(19) United States
(12) Patent Application Publication
(10) Pub. No.: US 2026/0171853 A1
(43) Pub. Date: Jun. 18, 2026

(54) METHOD AND CIRCUITRY FOR CONTROLLING A TRANSMITTER OF A WIRELESS POWER TRANSFER SYSTEM

(71) Applicant: Solace Power Inc., Mount Pearl (CA)

(72) Inventors: Dominic JEYAMANOHARAN, St. John's (CA); Anthony PENNEY, Grand Falls-Windsor (CA); Rasool KAHANI, St. John's (CA)

(73) Assignee: Solace Power Inc., Mount Pearl, NL (CA)

(21) Appl. No.: 19/422,617

(22) Filed: Dec. 17, 2025

Related U.S. Application Data
(60) Provisional application No. 63/735,325, filed on Dec. 18, 2024.

(51) Int. Cl. H02J 50/70; H02J 50/12

(52) U.S. Cl. CPC H02J 50/70; H02J 50/12

(57) ABSTRACT

A method of reducing a duty cycle of a switching element of an inverter of a transmitter of a wireless power transfer system to reduce electromagnetic interference (EMI) of a field generated by the transmitter is described. Circuitry, a transmitter and a wireless power transfer system are also described. The method comprises reducing a period of time a switching element of the inverter is active during each cycle of an operating frequency of the inverter thereby reducing the duty cycle of the switching element.

### CROSS-REFERENCE TO RELATED APPLICATION

This application claims the benefit of U.S. Provisional Ser. No. 63/735,325, filed Dec. 18, 2024, the entire content of which is hereby incorporated by this reference.

### FIELD

The subject disclosure relates generally to wireless power transfer, and in particular, to reducing a duty cycle of a switching element of an inverter of a transmitter in a wireless power system.

### BACKGROUND

Wireless power transfer systems such as wireless charging are becoming an increasingly important technology to enable the next generation of devices. The potential benefits and advantages offered by the technology is evident by the increasing number of manufacturers and companies investing in the technology.

A variety of wireless power transfer systems is known. A typical wireless power transfer system includes a power source electrically connected to a wireless power transmitter, and a wireless power receiver electrically connected to a load.

The transmitter may generate an electric or magnetic field to transfer to the receiver via electric or magnetic field coupling. While electromagnetic energy is produced in electric systems, the majority of power transfer occurs via the electric field. Little, if any, power is transferred via magnetic field coupling. Similarly, while electromagnetic energy is produced in magnetic systems, the majority of power transfer occurs via the magnetic field. Little, if any, power is transferred via electric field coupling.

While wireless power transfer system including a transmitter and receiver are known, improvements are desired. Accordingly, it is an object of the disclosure to improve wireless power transfer. It is a further objection of the disclosure to improve power transfer efficiency and/or reduce electromagnetic interference (EMI) of wireless power transfer.

This background serves only to set a scene to allow a person skilled in the art to better appreciate the following description. Therefore, none of the above discussion should necessarily be taken as an acknowledgement that that discussion is part of the state of the art or is common general knowledge. One or more aspects/embodiments of the disclosure may or may not address one or more of the background issues.

### SUMMARY

According to an aspect of the disclosure there is provided a method of reducing a duty cycle of a switching element of an inverter of a transmitter of a wireless power transfer system to reduce electromagnetic interference (EMI) of a field generated by the transmitter.

An inverter may be used in a transmitter of a wireless power transfer system to convert an input DC signal into an output AC signal for a transmit element (e.g., coil and/or capacitive element) to generate a field (e.g., magnetic or electric field) for wireless power transfer via field coupling.

The inverter of the transmitter may have issues related to power efficiency and/or EMI performance. In particular, the inverter may exhibit high levels of second, third and higher-order power harmonics. These power harmonics may reduce the power efficiency of the inverter. Such reduction in power efficiency may negatively affect the power transfer efficiency of a wireless power transfer having a transmitter with the inverter. Further, increased harmonics may increase the EMI from a field generated by the transmitter. This may negatively affect use cases of the transmitter for wireless power transfer as EMI may negatively affect other electronics, people and/or animals. Further power efficiency and/or EMI issues may lead to energy losses through the addition of filters, suboptimal power delivery, and difficulties in meeting regulatory standards for electromagnetic emissions.

For example, Class-E inverters (i.e., inverters which have a Class-E topology) may exhibit issues related to power efficiency and/or EMI especially, but not limited to, as high frequencies, e.g., frequencies over 1 MHz. These issues may be partially related to high levels of higher-order harmonics. While it may be possible to replace a Class-E inverter with a Class-D inverter, this may introduce other issues. For example, Class-D inverters generally have more switches (switching elements) than Class-E inverters. As such, they may be bulkier and not suitable for all use-cases. Further, more switches may increase heat generation which may also make Class-D inverter not suitable for all use-cases. Additionally, the power signal output by a Class-D inverter has significantly greater/more harmonics than a Class-E inverter. Complex controllers may be able to reduce these harmonics; however, these increase engineering efforts and the required electrical components.

The described aspects may at least partially address these issues.

According to an aspect of the disclosure there is provided a method of reducing a duty cycle of a switching element of an inverter of a transmitter of a wireless power transfer system to reduce electromagnetic interference (EMI) of a field generated by the transmitter, the method comprising:
reducing a period of time a switching element of the inverter is active during each cycle of an operating frequency of the inverter thereby reducing the duty cycle of the switching element.

As mentioned above, inverters, such as conventional Class-E inverters, face with power efficiency and EMI, particularly at high frequencies. The described method reduced a duty cycle of a switching element of an inverter, which reduces EMI. EMI may be caused by harmonics of the output of the inverter while maintaining the required power efficiency. One would normally consider that reducing the duty cycle of the switching element would negatively affect power efficiency, but it has been found that doing so does not substantially impact power efficiency, but does reduce EMI. This may offer more freedom of use of the inverter.

Reducing the duty cycle of the inverter may yield significant improvements in harmonic reduction. In particular, the reduced duty cycle may reduce higher-order harmonics in the power signal output by the inverter and therefore in the field generated by the transmitter. This reduction in higher-order harmonics may offer several benefits. For example, the output signal from the inverter may not require filtering due to the reduce harmonics. This may reduce the form factor of the transmitter as well as reducing power reductions caused by such filtering. Operating at a reduced duty cycle may be believed to be less efficient (i.e., reduced power transfer efficiency), the reduction of higher-order harmonics may minimize power losses in passive components (e.g., inductors and capacitors) of the transmitter. As such, the resulting reduction in power transfer efficiency may be negligible. Further, the power quality of the electrical power transferred from the transmitter to a receiver of a wireless power transfer system may be improved. Power quality may refer to the output power waveform. It is desirable to have a waveform that is stable in terms of its amplitude, continuity, waveform shape, and/or frequency. Increased harmonics, in particular increased higher order harmonics, may result in a power waveform that has a signal at the fundamental frequency that is not sufficiently high (i.e., the amplitude is too low) without filtering. The total harmonic distortion (THD) of the power signal may reduced by reducing the duty cycle as described. Additionally, increased harmonics may change the amplitude of the power waveform. The amplitude may be beyond an acceptable value at the fundamental frequency. Reducing the duty cycle and therefore reducing harmonics, e.g., higher order harmonics, may reduce the amplitude of the power waveform to acceptable levels.

Still further, a switching waveform of the switching element may be improved. In particular, the switching waveform may become more sinusoidal. The reduced duty cycle may have less noise. As such, the transmitter may be efficient and/or effective for wireless power transfer.

Further, as will be described, the duty cycle of a switching element of an existing inverter may be reduced with relatively minimal hardware changes. This makes the method a cost effective solution and scalable for a variety of applications. Further, the method may be suitable for retrofitting existing inverters, e.g., Class-E inverters. These minimal hardware changes may not require the addition of complicated, large, heat generating, and/or power intensive electrical components such as microcontrollers, processors, integrated circuits, etc.
While a period of time is referred to, a percentage of time may instead be referred with reference to a total cycle of an operating frequency of the inverter (i.e., the period for a given frequency).

The period of time may be reduced to a non-zero time.

A cycle may be a switching cycle of the switching element. The switching element may switch during each switching cycle according to the operating frequency. That is to say, the switching element may be active or closed for a portion of the time, and inactive or open for a portion of the time according to the operating frequency. The portion of time the switching element is active or closed may be referred to as the duty cycle.

The method may comprise reducing the period of time for each cycle of the operating frequency. That is the period of time may be reduced to the same level for each cycle of the switching element.

The operating frequency may represent the switching frequency of the switching element of the inverter. As such, the switching element may normally switch between states according to the operating frequency, but do so for a reduced period of time following the reducing.

Reducing the period of time may be for reducing EMI of a field generated by the transmitter comprising the inverter.

Reducing the period may comprise reducing the period of time for each cycle of operation of the switching element. The period of time may be reduced for each cycle by the same duration of time.

A switching element of an inverter may have a duty cycle of 50% under normal operation. This may mean the switching element is closed for 50% of the time, and open for 50% of the time. Reducing the period of time the switching element is active during each cycle may comprise reducing these duty cycle to less than 50%. This means the switching element is closed for less than 50% of the time, and open for more than 50% of the time. This reduction may be consistent and constant. This is in contrast with pulse width modulation, in which the widths of pulses are varied between cycles to communicate data.

Reducing the period of time may occur while the inverter is maintained in an operational state. In other words, the inverter is not deactivated or shutdown while the period of time is reduced, rather the inverter is operational during the reducing.

The duty cycle may be a ratio of time the switching element is active to a total period of time. For example, in Class-E inverters, the duty cycle of a switching element may be 50% where the switching element is active or closed for 50% of a total period, and open or inactive for the remaining 50% of the total period. Reducing the duty cycle may thus reduce the ratio from 50% or 1:2 to a lesser amount such as 25% or 1:4.

The duty cycle may be a proportion of time a switching element is active during each cycle of operation of the switching element. Reducing may therefore comprise reducing the proportion of time for each cycle of operation of the switching element. Further, unlike modulation schemes, the duty cycle may be reduced to a same pre-set level for each cycle. There may be no variation of the duty cycle between cycles of operation of the switching element.

Reducing the period of time may comprise reducing the period of time for a prolonged duration of time without interruption. The period of time may not change between cycles of operation of the switching element, but rather the period of time may be at a constant value during each cycle.

Reducing may comprise setting, for each cycle, a percentage or period of time a gate signal output by a gate driver for controlling a switching element of the inverter is high to reduce the period of time the switching element is active. Reducing may comprise adjusting, for each cycle, a percentage or period of time a gate signal output by a gate driver for controlling a switching element of the inverter is high to reduce the period of time the switching element is active. The gate driver may form part of the inverter. The gate driver may be electrically connected to the switching element.

The duty cycle may be reduced to half or less than of a non-reduced value. The reduced duty cycle may be a non-zero value. The duty cycle may be reduced to 35%, 30%, 25%, or 20% of a period of each cycle of the switching element.

Reducing the period of time may comprise reducing the duty cycle to 35%, 30%, 25%, or 20% of a period of each cycle of the switching element.

Reducing may comprise reducing the period of time for a sustained duration of time. The duration of time may be greater than a single switching cycle of the switching element.

Reducing may comprise reducing the period of time across all load conditions. It may that in the related art, a period of time may be reduced for a particular load or in order to communicate particular information. In contrast, the described reducing comprises reducing the period of time across all possible load conditions as the reduction is load-independent. Further, the reduction is not tied to encoding particular information for communication.

Reducing the duty cycle may comprise retuning a resonant circuit of the inverter for load independent operation of the inverter. Retuning the resonant circuit may comprise varying component values of the resonant circuit. Component values may be varied without changing a circuit topology of the resonant circuit and/or of the inverter.

Reducing the period of time may comprise outputting a reduced signal controlling the switching element.

Outputting the reduced signal may comprise filtering an output of an oscillator. The oscillator may output a periodic signal at twice the operating frequency. For example, if the operating frequency is 13.56 MHz, the oscillator output may have a frequency of 27.12 MHz.

Outputting the reduced signal may comprise performing one or more logical operations on an output of an oscillator and/or a flip-flop. The logical operations may comprise AND operations. In other words, the output of the oscillator and the flip-flop may be inputs to one or more AND gates.

Outputting the reduced signal may comprise performing one or more logical operations via one or more logic gates. In some cases, outputting the reduced signal may comprise performing delay line logic in conjunction with logic gates to produce the duty cycle output. The logic gages may comprise one more AND gates.

The reduced signal may comprise a gate signal controlling a gate driver controlling the switching element. The gate driver may be electrically connected to the switching element. The gate driver and the switching element may form part of the inverter.

The inverter may comprise a Class-E inverter. That is to say, the inverter may have a Class-E circuit topology.

The inverter may be adapted for use at high frequencies. High frequencies may be frequencies over 1 MHz. High frequencies may include at least 13.56 MHz and 27.12 MHz.

The switching element may comprise a transistor. The transistor may comprise a gallium nitride (GaN) or silicon carbide (SIC) transistor. In other cases, a metal-oxid-semiconductor field-effect transistors (MOSFETs) may be used. The inverter may comprise a high frequency Class-E inverter. In this context, high frequency may refer to frequencies over 1 MHz. Reducing the duty cycle of switching element may be challenging at such high frequencies. Utilizing GaN or SIC transistors may ensure the inverter operates in a stable manner.

According to another aspect there is provided circuitry for reducing a duty cycle of a switching element of an inverter of a transmitter of a wireless power transfer system to reduce electromagnetic interference (EMI) of a field generated by the transmitter, the circuitry adapted to:
reduce a period of time a switching element of the inverter is active during each cycle of an operating frequency of the inverter thereby reducing the duty cycle of the switching element.

The circuitry may comprise any of the features and/or benefits described in respect of the method.

The circuitry may be adapted to set, for each cycle, a percentage of time a gate signal output by a gate driver for controlling a switching element of the inverter is high to reduce the period of time the switching element is active.

The circuitry may be adapted to adjust, for each cycle, a percentage or period of time a gate signal output by a gate driver for controlling a switching element of the inverter is high to reduce the period of time the switching element is active. The gate driver may form part of the inverter. The gate driver may be electrically connected to the switching element.

The duty cycle is reduced to half or less than of a non-reduced value. The reduced duty cycle may be a non-zero value. The duty cycle may be reduced to 35%, 30%, 25%, or 20% of a period of each cycle of the switching element. The circuitry may be adapted to reduce the duty cycle to 35%, 30%, 25%, or 20% of a period of each cycle of the switching element.

The circuitry may be adapted to output a reduced signal controlling the switching element. Outputting the reduced signal may comprise filtering an output of an oscillator. The oscillator may output a periodic signal at twice the operating frequency. For example, if the operating frequency is 13.56 MHz, the oscillator output may have a frequency of 27.12 MHz.

The circuitry may comprise a filter adapted to filter an output of an oscillator for controlling a duty cycle of a switching element of an inverter. The filter may be for electrical connection to an oscillator and a gate driver driving a switching element of an inverter. The filter may comprise one more RC components (i.e., resistive and/or capacitive components, e.g., resistors, capacitors). The filter may comprise a flip-flop connected to RC components.

The circuitry may comprise a flip-flop and one or more logic gates. The logic gates may be electrically connected to the flip-flop. The flip-flop may be adapted to output a reduced gate signal for controlling a switching element of an inverter to reduce the duty cycle of the inverter. The flip-flop may be for electrical connection to an oscillator. The logic gates may be for electrical connection to an oscillator.

The circuitry may comprise an oscillator for outputting an oscillating signal. In particular, the circuitry may comprise the described oscillator. Alternatively, the oscillator may be separate and distinct from the circuitry. A frequency of the oscillating signal may be twice the operating frequency of the inverter. For example, if the operating frequency is 13.56 MHz, the oscillator output may have a frequency of 27.12 MHz.

According to another aspect there is provided an inverter for receiving an direct current (DC) power signal and outputting an alternating current (AC) power signal for driving a transmit element of a transmitter of a wireless power transfer system, the inverter comprising:
a switching element having a period of time during which the switching element is active or closed and a remaining period of time during which the switching element is inactive or open in operation;
a gate driver for controlling operation of the switching element; and
circuitry for reducing the period of time during which the switching element is active or closed to reduce electromagnetic interference (EMI) of a field generated a transmitter of a wireless power transfer system.

The circuitry may comprise any of the previously described features and/or benefits described.

While the gate driver has been described as separate and distinct from the circuitry, the gate driver may form part of the circuitry.

While a single switching element and gate driver have been described, one of skill in the art will appreciate that multiple switching element and/or gate drivers may be present in the inverter.

For example, the circuitry may be adapted to set, for each cycle, a percentage of time a gate signal output by the gate driver for controlling the switching element of the inverter is high to reduce the period of time the switching element is active or closed.

The circuitry may be adapted to adjust, for each cycle, a percentage or period of time a gate signal output by the gate driver for controlling the switching element of the inverter is high to reduce the period of time the switching element is active or closed.

The gate driver may be electrically connected to the switching element.

The duty cycle is reduced to half or less than of a non-reduced value. The reduced duty cycle may be a non-zero value. The duty cycle may be reduced to 35%, 30%, 25%, or 20% of a period of each cycle of the switching element. The circuitry may be adapted to reduce the duty cycle to 35%, 30%, 25%, or 20% of a period of each cycle of the switching element.

The circuitry may be adapted to output a reduced signal controlling the switching element via the gate driver. Outputting the reduced signal may comprise filtering an output of an oscillator. The oscillator may output a periodic signal at twice the operating frequency. For example, if the operating frequency is 13.56 MHz, the oscillator output may have a frequency of 27.12 MHz.

The circuitry may comprise a filter adapted to filter an output of an oscillator for controlling a duty cycle of the switching element. The filter may be for electrical connection to an oscillator and the gate driver driving the switching element. The filter may comprise one more RC components (i.e., resistive and/or capacitive components, e.g., resistors, capacitors). The filter may comprise a flip-flop connected to RC components.

The circuitry may comprise a flip-flop and one or more logic gates. The logic gates may be electrically connected to the flip-flop. The flip-flop may be adapted to output a reduced gate signal for controlling the switching element to reduce the duty cycle of the switching element or inverter. The flip-flop may be for electrical connection to an oscillator. The logic gates may be for electrical connection to an oscillator.

The circuitry may comprise an oscillator for outputting an oscillating signal. In particular, the circuitry may comprise the described oscillator. Alternatively, the oscillator may be separate and distinct from the circuitry. The oscillator may form part of the inverter. In other words, the inverter may further comprise an oscillator for outputting an oscillating signal. The circuitry may be electrically connected to the oscillator. A frequency of the oscillating signal may be twice the operating frequency of the inverter. For example, if the operating frequency is 13.56 MHz, the oscillator output may have a frequency of 27.12 MHz.

According to another aspect there is provided a transmitter for generating a field for wireless transferring power from the transmitter to a receiver of a wireless power transfer system, the transmitter comprising:
an inverter electrically connected to a transmit element of the transmitter for outputting an alternating current (AC) power signal for driving the transmit element to generate the field to wirelessly transfer power; and
circuitry for reducing a duty cycle of a switching element of an inverter of a transmitter of a wireless power transfer system to reduce electromagnetic interference (EMI) of a field generated by the transmitter, the circuitry adapted to reduce a period of time a switching element of the inverter is active during each cycle of an operating frequency of the inverter thereby reducing the duty cycle of the switching element.

The transmitter may comprise any of the features and/or benefits described in respect of the method and/or circuitry.

The transmitter may further comprise:
the transmit element for generating the field for wireless power transfer, the transmit element electrically connected to the inverter. The transmit element may be electrically connected to an output of the inverter. The transmit element may receive an AC signal output by the inverter.

The transmit element may be configured to transfer power via resonant or non-resonant electric or magnetic field coupling. The transmit element may comprise one or more receive coils (i.e. inductors) or one or more capacitive electrodes. A corresponding receiver may comprise corresponding receive coils (i.e. inductors) or capacitive electrodes, respectively.
The transmitter may further comprise:
a power source electrically connected to the inverter. The power source may comprise a power supply. The power source may comprise mains power, a battery (rechargeable or not), or source of electrical power.

According to another aspect there is provided a wireless power transfer system comprising:
a transmitter for generating a field for wireless transferring power from the transmitter to a receiver, the transmitter comprising:
   an inverter electrically connected to a transmit element of the transmitter for outputting an alternating current (AC) for driving the transmit element to generate the field to wirelessly transfer power; and
   circuitry for reducing a duty cycle of a switching element of an inverter of a transmitter of a wireless power transfer system to reduce electromagnetic interference (EMI) of a field generated by the transmitter, the circuitry adapted to reduce a period of time a switching element of the inverter is active during each cycle of an operating frequency of the inverter thereby reducing the duty cycle of the switching element; and
the receiver for extracting power from a field generated by the transmitter.

The wireless power transfer system may comprise any of the features and/or benefits described in respect of the method, circuitry and/or transmitter.

The transmit element may be configured to transfer power via resonant or non-resonant electric or magnetic field coupling. The transmit element may comprise one or more receive coils (i.e. inductors) or one or more capacitive electrodes.

The receiver may comprise:
a receive element for coupling to the field generated by the transmitter to extract power from the field.

The receive element may comprise corresponding receive coils (i.e. inductors) or capacitive electrodes, respectively.

The receiver may comprise at least one of:
a rectifier electrically connected to the receive element for rectifying a received alternating current (AC) signal to direct current (DC); and
a load electrically connected to the receive element.

The load may be directly connected to the receive element or be connected to the receive element via the rectifier. The load may be a DC load.

The phrase “electrically connected” may refer to a direct electrical connection between two elements, or an indirect electrical connection between two elements with one or more additional elements between the two elements, unless otherwise stated.

The disclosure includes one or more corresponding aspects, embodiments or features in isolation or in various combinations whether or not specifically stated (including claimed) in that combination or in isolation. As will be appreciated, features associated with particular arrangements relating to systems may be equally appropriate as features of embodiments relating specifically to methods of operation or use, and vice versa.
The above summary is intended to be merely exemplary and non-limiting.

### BRIEF DESCRIPTION OF THE DRAWINGS

A description is now given, by way of example only, with reference to the accompanying drawings, in which:

FIG. 1 is a block diagram of a wireless power transfer system;

FIG. 2 is a block diagram of an inverter of the wireless power transfer system of FIG. 1 in accordance with an aspect of the disclosure;

FIG. 3 is a circuit diagram of the inverter of FIG. 2;

FIG. 4a is a circuit diagram of a portion of the inverter of FIG. 3;

FIG. 4b is a circuit diagram of another arrangement of a portion of the inverter of FIG. 3;

FIG. 5 is a flowchart of operation of a method of reducing a duty cycle of a switching element of an inverter of a transmitter of a wireless power transfer system in accordance with an aspect of the disclosure;

FIG. 6 is a graph of voltage of an inverter at various frequencies and duty cycles;

FIGS. 7a-7c are graphs of power transfer efficiency compared to output current of an inverter at various frequencies and duty cycles;

FIG. 8 is a graph of magnetic field strength of a transmitter at various frequencies and duty cycles; and

FIG. 9 is a graph of electric field strength of a transmitter at various frequencies and duty cycles.

### DETAILED DESCRIPTION

The foregoing summary, as well as the following detailed description of certain examples will be better understood when read in conjunction with the appended drawings. As used herein, an element or feature introduced in the singular and preceded by the word “a” or “an” should be understood as not necessarily excluding the plural of the elements or features. Further, references to “one example” or “one embodiment” are not intended to be interpreted as excluding the existence of additional examples or embodiments that also incorporate the described elements or features. Moreover, unless explicitly stated to the contrary, examples or embodiments “comprising” or “having” or “including” an element or feature or a plurality of elements or features having a particular property may include additional elements or features not having that property. Also, it will be appreciated that the terms “comprises”, “has”, “includes” means “including by not limited to” and the terms “comprising”, “having” and “including” have equivalent meanings. It will also be appreciated that like reference characters will be used to refer to like elements throughout the description and drawings.

As used herein, the terms “adapted” and “configured” mean that the element, component, or other subject matter is designed and/or intended to perform a given function. Thus, the use of the terms “adapted” and “configured” should not be construed to mean that a given element, component, or other subject matter is simply “capable of” performing a given function but that the element, component, and/or other subject matter is specifically selected, created, implemented, utilized, and/or designed for the purpose of performing the function. It is also within the scope of the subject application that elements, components, and/or other subject matter that is described as being adapted to perform a particular function may additionally or alternatively be described as being configured to perform that function, and vice versa. Similarly, subject matter that is described as being configured to perform a particular function may additionally or alternatively be described as being operative to perform that function.

It will be understood that when an element is referred to as being “on,” “attached” to, “connected” to, “coupled” with, “contacting,” etc., another element, it can be directly on, attached to, connected to, coupled with or contacting the other element or intervening elements may also be present.

It should be understood that use of the word “exemplary”, unless otherwise stated, means ‘by way of example’ or ‘one example’, rather than meaning a preferred or optimal design or implementation.

Unless defined otherwise, all technical and scientific terms used herein have the same meaning as is commonly understood by one of skill in the art to which the subject disclosure pertains.

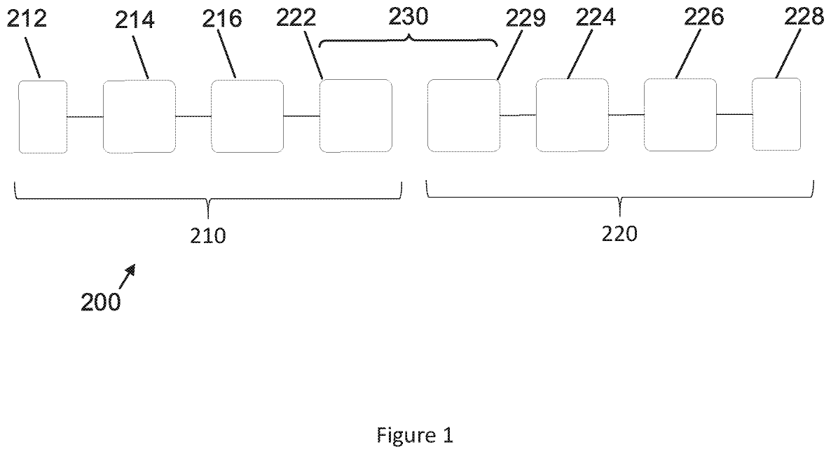

Turning now to FIG. 1, an arrangement of a wireless power transfer system is shown generally identified as reference numeral 200. The wireless power transfer system 200 comprises a power supply 212, DC/DC converter 214, inverter 216, and transmit or transmitter element 222. The power supply 212 is electrically connected to the DC/DC converter 214. The DC/DC converter 214 is electrically connected to the inverter 216. The inverter 216 is electrically connected to the transmitter element 222.

The power supply 212 is for generating an input power signal for transmission of power. In this embodiment, the input power signal is a direct current (DC) power signal.

The DC/DC converter 214 is for converting a received DC voltage signal to a desired voltage level. The received DC voltage may be from the power supply 212. The system 200 is illustrated as comprising the DC/DC converter 214, one of skill in the art will appreciate other configurations are possible. In another embodiment, no DC/DC converter is present.

In the illustrated arrangement, the inverter 216 comprises various components including an output stage. The output stage matches the output impedance of the inverter 216 to the optimum impedance of a wireless link 230 between the transmitter and receiver. The output stage may also set the desired impedance presented to the inverter 216. The output stage may be used to filter high frequency harmonic components of the inverter 216.

One of skill in the art will appreciate that the output stage may be omitted. Omitting the output stage, especially filtering elements of the output stage may reduce the overall size of the inverter 216 allowing for broader applications of the transmitter 210, and/or may improve performance of the inverter 216 as filtering elements may be lossy and/or heat generating.

The transmitter element 222 comprises one or more capacitive electrodes and inductive elements, i.e., inductors. The capacitive electrodes may be laterally spaced, elongated electrodes; however, one of skill in the art will appreciate that other configurations are possible including, but not limited to, concentric, coplanar, circular, elliptical, disc, etc., electrodes. Other suitable electrode configurations are described in applicant's U.S. Pat. No. 9,979,206B2, the relevant portions of which are incorporated herein by reference. The inductive elements may comprise one or more coils. The coils may include booster or shield coils such as described in applicant's U.S. patent application Ser. No. 17/193539, the relevant portions of which are incorporated herein by reference. The transmitter element 222 may further include resonator elements for resonating the capacitive electrodes and inductive elements, i.e., capacitors and inductors.

The power source 212 supplies a DC input power signal to the DC/DC converter 214, which converts the signal to a desired voltage level. The inverter 216 receives the converted DC power signal and converts the DC power signal to AC to allow the ability to generate a magnetic and/or electric field at the transmitter element 222 to transfer power via electric or magnetic field coupling. Specifically, the transmitter element 222 generates a magnetic/electric field to transfer power to the receiver via magnetic/electric field coupling. The power source 212, DC/DC converter 214, inverter 216 and transmitter element 222 may collectively form a transmitter 210. As previously stated, the DC/DC converter 214 may not be present in the transmitter 210.

The wireless power transfer system 200 further comprises load 228, DC/DC converter 226, rectifier 224, and receive or receiver element 229. The load 228 is electrically connected to the DC/DC converter 226. The DC/DC converter 226 is electrically connected to the rectifier 224. The rectifier 224 is electrically connected to the receiver element 229.

In the illustrated arrangement, the load 228 is a DC load. The load 228 may be static or variable.

The DC/DC converter 226 is for converting a received DC voltage signal to a desired voltage level. The received DC voltage may be from the circuitry 224. While the system 200 comprises the DC/DC converter 226, one of skill in the art will appreciate other configurations are possible. In another embodiment, no DC/DC converter 226 is present.

The rectifier 224 comprises an input stage and rectifier circuitry. The input stage is configured to ensure optimum impedance presented to the receiver element 229 at the full power state of the wireless power transfer system 200. The input stage may also preserve the quasi-voltage source behaviour of the receiver element 229 so the output of the rectifier 224 exhibits a stable DC voltage from no load to full load conditions. One of skill in the art will appreciate that the input stage may be omitted. The rectifier 224 may comprise a synchronous rectifier such as applicant's own rectifier described in U.S. Pat. No. 11,637,453 B2, the relevant portions of which are incorporated herein by reference.

The receiver element 229 comprises one or more capacitive electrodes and inductive elements, i.e., inductors. The capacitive electrodes may be laterally spaced, elongate electrodes; however, one of skill in the art will appreciate that other configurations are possible including, but not limited to, concentric, coplanar, circular, elliptical, disc, etc., electrodes. Other suitable electrode configurations are described in applicant's U.S. Pat. No. 9,979,206B2, the relevant portions of which are incorporated herein by reference. The inductive elements may comprise one or more coils. The coils may include booster or shield coils such as described in applicant's U.S. patent application Ser. No. 17/193539, the relevant portions of which are incorporated herein by reference.

The transmitter and receiver elements 222, 229 of the system 200 form the wireless link 230. The elements 222, 229 are separated by a wireless gap. The wireless gap may be formed by atmosphere, i.e., air, or by a physical medium, e.g., walls, glass, liquids, wood, insulations, etc. Power is transferred from one element to the other across the wireless link 230 via resonant or non-resonant magnetic and/or electric field coupling, i.e., electric or magnetic induction.

During operation, the receiver element 229 extracts power from a magnetic and/or electric field generated by the transmitter element 222. The rectifier 224 rectifies the received power signal. The DC/DC converter 226 converts the rectified power signal to the desired power level, which is received by the load 228. In this way, the receiver element 229 extracts power transmitted by the transmitter element 222 (transmitter 210) such that electrical power is transferred to the load 228 via magnetic/electric field coupling. The load 228, DC/DC converter 226, rectifier 224 and receiver element 229 may collectively form a receiver 220. As previously stated, the DC/DC converter 226 may not be present in the receiver 220.

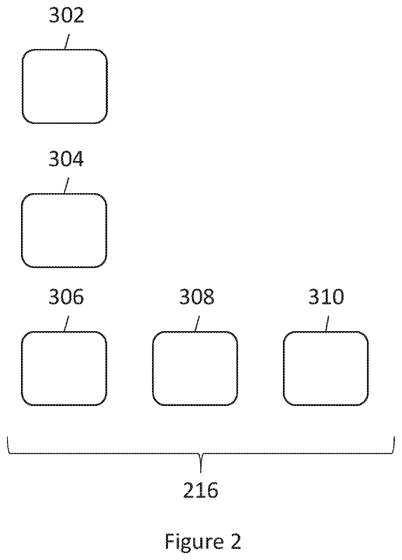

Turning now to FIG. 2, a block diagram of the inverter 216 is illustrated. The inverter 216 is adapted to convert the converted DC power signal from the DC/DC converter 214 to an alternating current (AC) signal. The inverter 216 may comprise a high frequency power inverter. The inverter 216 may be a Class-E inverter.

The inverter 216 comprises circuitry 302, specifically duty control circuitry; an oscillator 304; a gate driver 306; a switching element 308; and an output stage 310. As previously stated, the output stage 310 may be omitted. While a single gate driver 306 and switching element are illustrated, one of skill in the art will appreciate the inverter 216 may comprise multiple gate drivers 306 (e.g., two gate drivers) and multiple switching elements (e.g., two switching elements). Each gate driver 306 may be associated with a respective switching element.

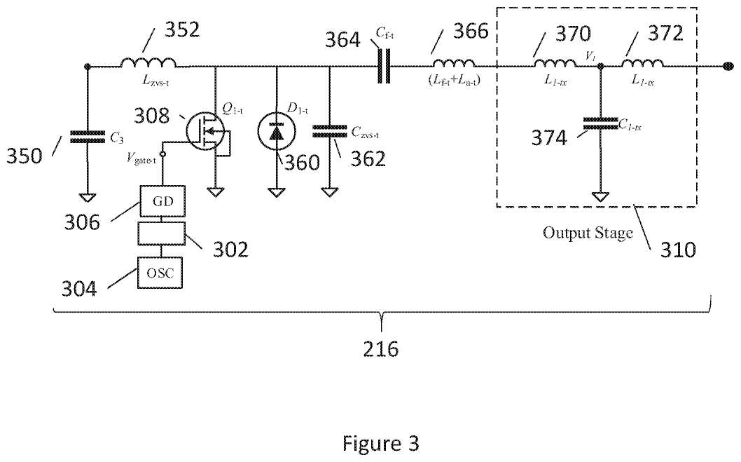

Turning now to FIG. 3, a circuit diagram of the inverter 216 is illustrated. While the circuit diagram includes the output stage 310, one of skill in the art will appreciate the output stage 310 may be omitted.

In the illustrated arrangement, the inverter 216 comprises capacitor 350, inductor 352, gate driver 306, circuitry 302, oscillator 304, switching element 308 (e.g., the main switch of the inverter 216), diode 360, capacitor 362, capacitor 364, and inductor 366. The capacitor 350 having capacitance C3 is connected in parallel to the DC/DC converter 214. The capacitor 350 is electrically connected to a node in which inductor 352 is connected. The inductor 352 has inductance LZVS-t. The capacitor 350 is connected in parallel to the switching element 308 indicated as Q1-t.

In the illustrated arrangement, the switching element 308 comprises an n-type MOSFET. While an n-type MOSFET has been illustrated, one of skill in the art will appreciate other FETs and switching devices may be used.

The switching element 308 is electrically connected to the gate driver 306. The gate driver 306 drives the switching element 308 of the inverter 216. The oscillator 304 is electrically connected to the switching element 308 via the circuitry 302. The circuitry 302 reduces a period of time the switching element 308 is active during each cycle of an operating frequency of the inverter 216 thereby reducing the duty cycle of the switching element 308 as will be described. One of skill in the art will appreciate the oscillator 304 may comprise any signal generator.

The oscillator 304 is adapted to generate a clock signal to control the gate driver 306 via the circuitry 302 connected to the switching element 308 to invert the inputted power signal from the power source 212 (via the DC/DC converter 214) to an RF or AC signal.

The inverter 216 further comprises a diode 360 indicated as D1-t electrically connected in parallel to the switching element 308, and the capacitor 362 having a capacitance CZVS-t electrically connected in parallel to the diode 360. The capacitor 362 is electrically connected to the capacitor 364 having a capacitance CZVS-t that is electrically connected in series to the inductor 366 having the inductance Lf-t+La-t. The switching element 308, diode 402 and capacitor 362 are connected in parallel between inductor 352 and capacitor 364. The switching element 308, diode 360 and capacitor 362 are all connected to a node. Specifically, the drain terminal of the switching element 308 is connected to the node. The inductor 352 and capacitor 364 are connected to the same node. The diode 360 and capacitor 362 are also connected to ground. The switching element 308 is connected to ground. Specifically, the source terminal of the switching element 308 is connected to ground. The gate terminal of the switching element is connected to the gate driver 306.

In the illustrated arrangement, the inverter 216 further comprises the output stage 310, although as previously stated, the output stage 310 may be omitted. The output stage 310 comprises inductor 370 having inductance L1-tx electrically connected in series to inductor 372 having inductance L1-tx with capacitor 374 having capacitance C1-tx electrically connected in parallel between the inductors 370, 372. The inductors 370, 372 and capacitor 374 are connected to the same node. The capacitor 374 is further connected to ground.

The output of the inverter 216 is connected to the transmitter element 222.

During operation, the oscillator 304 generates an oscillating signal, which controls operation of the gate driver 306 via the circuitry 302. The output of the gate driver 306 controls switching of the switching element 308, e.g., the transistor, such that the receive input DC power signal from the power supply 212 via the DC/DC converter 214 is inverted according to the duty cycle of the switching element 308. In this manner, the inverter 216 outputs an AC power signal for the transmit element 222 to generate a filed for wireless power transfer. This illustrated inverter 216 is a Class-E inverter 216 and as such, the duty cycle of the switching element is 50% of the operating frequency of the inverter 216 under normal operation. The operating frequency may be 13.56 MHz or 27.12 MHz.

The circuitry 302 operates to reduce a period of time the switching element 308 is active during each cycle of the thereby reducing the duty cycle of the switching element 308. As a result, higher order harmonics may be reduced, especially at high frequencies (e.g., greater than 1 MHz). Thus, performance of the inverter 216, transmitter 210, and wireless power transfer system 200 may be improved.

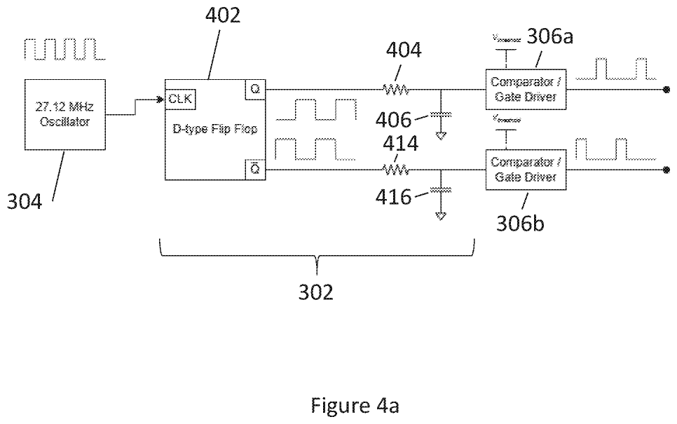

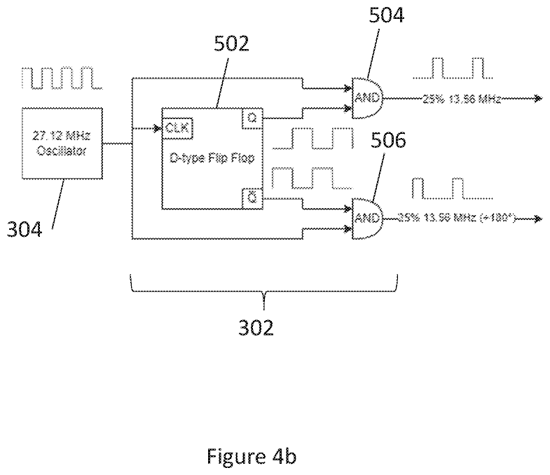

Turning now to FIGS. 4a and 4b, circuit diagrams of two arrangements of portions of the inverter 216 are illustrated. In FIG. 4a, an RC filter and an input threshold of the gate driver 306 are used to generate the desired reduced duty cycle. In this arrangement, the inverter 216 comprises the oscillator 304 outputting an oscillating signal at twice the operating frequency. In the illustrated arrangement, the operating frequency is 13.56 MHz, so the frequency of the oscillating signal is 27.12 MHz. The oscillator 304 is electrically connected to a flip-flop 402, which receives the oscillating signal as input (i.e., a clock). In the illustrated arrangement, the flip-flop 402 is a D-type flip-flop. The flip-flop 402 outputs two signals: a first signal that is the inverted clock signal having half the frequency of the oscillating signal, i.e., 13.56 MHz; and a second signal that is the non-inverted clock signal having half the frequency, i.e., 13.56 MHz.

The flip-flop 402 is electrically connected to a filter. In the illustrated arrangement, the flip-flop 402 is connected to two filters. In particular, two RC filters. The two signals output by the flip-flop 402 are filtered by the RC filters. The RC filters comprise resistor 404 connected in parallel to capacitor 406, and resistor 414 connected in parallel to capacitor 416. The resistive and capacitive values of the resistors 404, 414 and capacitors 406, 416 are selected to reduce the outputs of the flip-flop to the desired duty cycle (e.g., 35%, 30%, 25%, or 20% of the non-reduced signal). The filters are connected to gate drivers 306a/306b. The input threshold of the gate drivers 306a/306b generate the desired reduced control signal for receipt by the switching element 308. In particular, the output of the gate driver 306a controls operation of a first switching element (not shown) of the inverter 216, and the output of the gate driver 306a controls operation of a second switching element (not shown) of the inverter 216. The outputs of the gate drivers 306a/306b is a reduced continuous control signal, as shown in FIG. 4 a, which is reduces the duty cycle of the switching elements to approximately 25% of the period of the inverter 216. The period is based on the operating frequency of the inverter 216.

The arrangement illustrated in FIG. 4a is easily configurable as the values of the resistors 404, 414 and capacitors 406, 416 to achieve the desired reduction in duty cycle of the switching element 308.

Turning now to FIG. 4b, a circuit diagram of another arrangement of a portion of the inverter 216 is illustrated. In this arrangement, the oscillator 304, a flip-flop 502, and logic gates are utilised to reduce the duty cycle of the switching element 308. The oscillator 304 is adapted to output an oscillating signal at twice the operating frequency. In the illustrated arrangement, the operating frequency is 13.56 MHz, so the frequency of the oscillating signal is 27.12 MHz. The oscillator 304 is electrically connected to a flip-flop 502, which receives the oscillating signal as input (i.e., a clock). In the illustrated arrangement, the flip-flop 502 is a D-type flip-flop. The flip-flop 502 outputs two signals: a first signal that is the inverted clock signal having half the frequency of the oscillating signal, i.e., 13.56 MHz; and a second signal that is the non-inverted clock signal having half the frequency, i.e., 13.56 MHz.

The oscillator 304 and flip-flop 502 are further connected to logic gates. The logic gates comprise first and second AND gates 504, 506. The first output signal of the flip-flop 502 is received by the first AND gate 504 along with the oscillating signal output by the oscillator 304. The first output signal of the flip-flop 502 is received by the second AND gate 506 along with the oscillating signal output by the oscillator 304. The gates 504, 506 separately AND the oscillator 304 output with the outputs of the flip-flop 502 to generate two controls signals for controlling two switching elements (not shown) of the inverter 216. As such, in the illustrated arrangement, no additional gate drivers are required thereby reducing components, costs, and the size of the inverter 216. Put in other words, the AND gates 504, 506 may be considered to act or form gate drivers of the inverter 216 as they generate control signals for controlling operating of switching elements of the inverter 216.

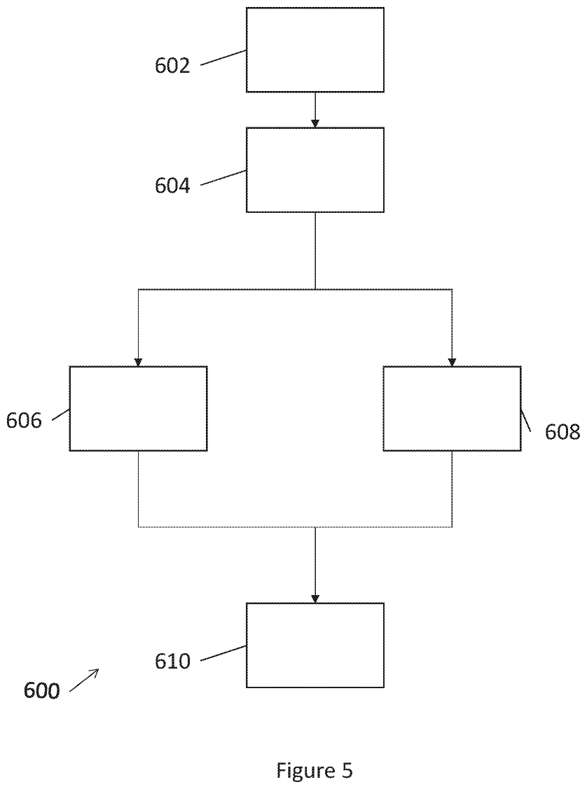

Turning now to FIG. 5, a flowchart of a method of reducing a duty cycle of a switching element (e.g., switching element 308) to reduce EMI is illustrated. The method 600 comprises reducing a period of time the switching element 308 is active during each cycle of an operating frequency of the inverter 216 thereby reducing the duty cycle of the switching element 308. Specifically, the method 600 comprises outputting 602 an oscillating signal from an oscillator (e.g., oscillator 304). The method 600 further comprises latching 604 the oscillating signal via, for example, the flip-flop 502, to output signals. The signals may be non-inverted and inverted signals of the oscillator 304 having half the frequency of the frequency of the oscillating signal.

The method 600 further comprises filtering 606 the signals output by the flip-flop 502 and driving one or more gate drivers 306 with the filtered signal. Alternatively, the method 600 may further comprise performing 608 one or more logical operations on the output of the oscillator 304 and the flip-flop 502. The method 600 may further comprise operating 610 the switching element 308 at the reduced duty cycle.

As described, the circuitry 302 reduces a duty cycle of the switching element 308 of the inverter 216 to reduce EMI of a field generated by the transmitter 210. This may reduce higher order harmonics. This was confirmed through simulation and/or modelling of an exemplary wireless power transfer system 200. In this exemplary system 200, the operating frequency was 13.56 MHz. The separation distance (i.e., the distance between the transmit element 222 and the receive element 229) during power transfer was 9 mm, although in some experimental arrangements this was varied to 12 mm and 15 mm. The input supply to the inverter 216 (or the output of the DC/DC converter 214) was 5 V. The received power was approximately 1.5 W. The transmit power was approximately double the received power.

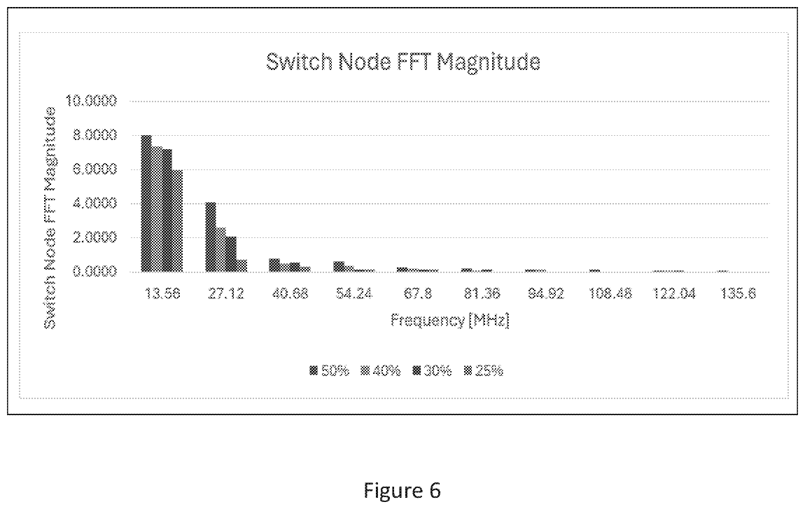

Turning now to FIG. 6, graph of voltage of the inverter 216 at various frequencies is illustrated. Specifically, the graph is a bar chart of magnitudes of a Fast Fourier Transform (FFT) of the switch node voltage of the switching element 308 at a duty cycle of 50% (unreduced), 40% (reduced), 30% (reduced), and 25% (reduced). Further, the FFT of the switch voltage is shown at the operating frequency of 13.56 MHz; and the second order harmonic, 27.12 MHz. Further, the FFT of the switch voltage is shown at various higher frequencies: 40.68 MHz, 54.25 MHz, 67.8 MHz, 81.36 MHz, 94.92 MHz, 108.48 MHz, 122.04 MHz, and 135.6 MHz. As shown in FIG. 6, the higher order harmonics are reduced when the duty cycle is reduced. In particular, at a duty cycle of 25%, the higher order harmonics are reduced to almost negligible levels.

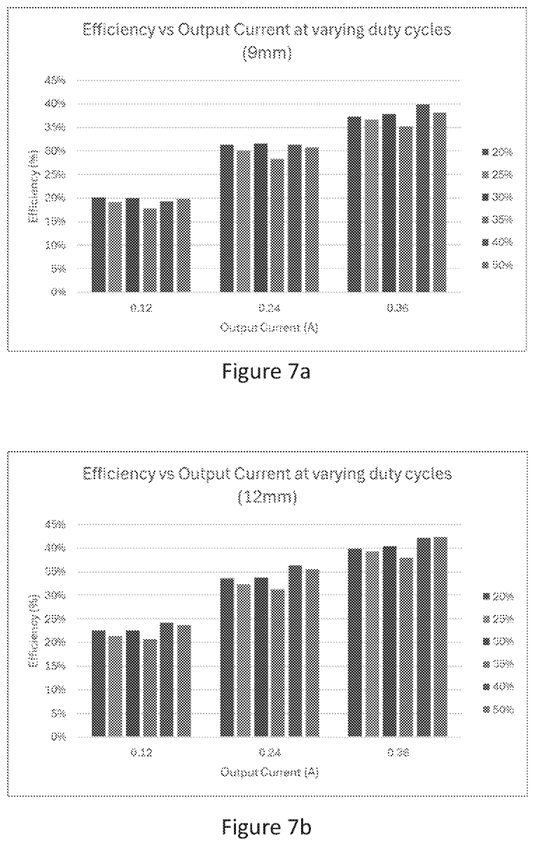

Turning now to FIGS. 7a-7c, power transfer efficiency of the wireless power transfer system 200 compared to output current of the inverter 216 at various frequencies and duty cycles is illustrated. The output current of the inverter 216 may be 0.12 A, 0.024 A, or 0.36 A. Further, the separation distance in FIG. 7a is 9 mm, while the separation distance in FIGS. 7b and 7c is 12 mm and 15 mm, respectively. The duty cycle is 50% (unreduced), 40% (reduced), 30% (reduced), and 25% (reduced). While there is variation in the power transfer efficiency at various duty cycles, it is evident that at a reduced duty cycle, the power transfer efficiency is close to the same as the power transfer efficiency at an unreduced duty cycle of 50%. This generally holds true across all output currents and separation distances.

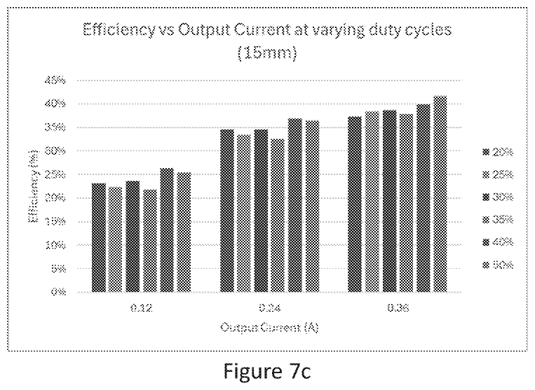

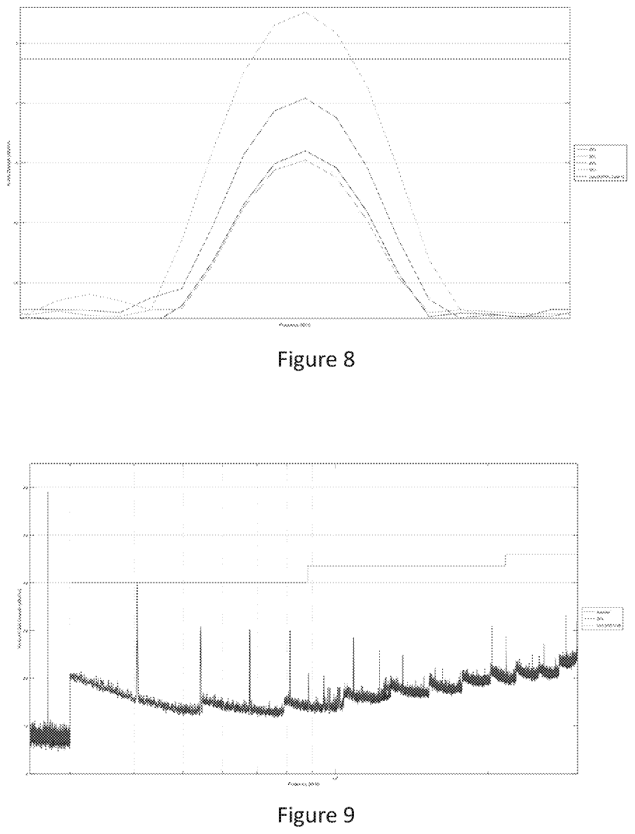

Turning now to FIGS. 8 and 9, graphs graph of magnetic and electric field strength of the transmitter 210 at various frequencies and duty cycles are illustrated. The graphs assess electromagnetic interference levels across different duty cycles. As illustrated in FIG. 8, a reduced duty cycle of 25% was found to exhibit the lowest magnetic field. A reduced duty cycle of 20% was found to exhibit a similarly low magnetic field. As illustrated in FIG. 9, a reduced duty cycle of 20% has lower electric field at various harmonic frequencies than the baseline unreduced duty cycle of 50%.

These graphs demonstrate a clear trend of reduction in higher-level harmonics with decreasing duty cycle. This reduction in harmonics results in lower EMI emissions, comparable efficiency, and better power quality.

It should be understood that the examples provided are merely exemplary of the present disclosure, and that various modifications may be made thereto.

1. Circuitry for reducing a duty cycle of a switching element of an inverter of a transmitter of a wireless power transfer system to reduce electromagnetic interference (EMI) of a field generated by the transmitter, the circuitry adapted to:
reduce a period of time a switching element of the inverter is active during each cycle of an operating frequency of the inverter thereby reducing the duty cycle of the switching element.

2. The circuitry of claim 1, wherein the circuitry is adapted to set, for each cycle, a percentage of time a gate signal output by a gate driver for controlling a switching element of the inverter is high to reduce the period of time the switching element is active.

3. The circuitry of claim 1, wherein the duty cycle is reduced to half or less than of a non-reduced value.

4. The circuitry of claim 2, wherein the circuitry is adapted to reduce the duty cycle to 35%, 30%, 25%, or 20% of a period of each cycle of the switching element.

5. The circuitry of claim 3, wherein the circuitry is adapted to output a reduced signal controlling the switching element.

6. The circuitry of claim 5, wherein the circuitry comprises a filter adapted to filter an output of an oscillator for controlling a duty cycle of a switching element of an inverter.

7. The circuitry of claim 5, wherein the circuitry comprises a flip-flop and one or more logic gates, the logic gates electrically connected to the flip-flop and adapted to output a reduced gate signal for controlling a switching element of an inverter to reduce the duty cycle of the inverter.

8. The circuitry of claim 5, wherein the circuitry comprises an oscillator for outputting an oscillating signal.

9. The circuitry of claim 8, wherein a frequency of the oscillating signal is twice the operating frequency of the inverter.

10. A method of reducing a duty cycle of a switching element of an inverter of a transmitter of a wireless power transfer system to reduce electromagnetic interference (EMI) of a field generated by the transmitter, the method comprising:
reducing a period of time a switching element of the inverter is active during each cycle of an operating frequency of the inverter thereby reducing the duty cycle of the switching element.

11. The method of claim 10, wherein reducing comprises setting, for each cycle, a percentage of time a gate signal output by a gate driver for controlling a switching element of the inverter is high to reduce the period of time the switching element is active.

12. The method of claim 10, wherein the duty cycle is reduced to half or less than of a non-reduced value, wherein reducing the period of time comprises reducing the duty cycle to 35%, 30%, 25%, or 20% of a period of each cycle of the switching element.

13. The method of claim 10, wherein the reducing comprises reducing the period of time for a sustained duration of time, or reducing the period of time across all load conditions.

14. The method of claim 10, wherein reducing the period of time comprises outputting a reduced signal controlling the switching element, wherein outputting the reduced signal comprises filtering an output of an oscillator, or performing one or more logical operations on an output of an oscillator and/or a flip-flop, wherein outputting the reduced signal comprises performing one or more logical operations via one or more logic gates.

15. The method of claim 14, wherein the reduced signal comprises a gate signal controlling a gate driver controlling the switching element.

16. A transmitter for generating a field for wireless transferring power from the transmitter to a receiver of a wireless power transfer system, the transmitter comprising:
an inverter electrically connected to a transmit element of the transmitter for outputting an alternating current (AC) for driving the transmit element to generate the field to wirelessly transfer power; and
circuitry for reducing a duty cycle of a switching element of an inverter of a transmitter of a wireless power transfer system to reduce electromagnetic interference (EMI) of a field generated by the transmitter, the circuitry adapted to reduce a period of time a switching element of the inverter is active during each cycle of an operating frequency of the inverter thereby reducing the duty cycle of the switching element.

17. The transmitter of claim 16, further comprising:
the transmit element for generating the field for wireless power transfer, the transmit element electrically connected to the inverter.

18. A wireless power transfer system comprising:
a transmitter for generating a field for wireless transferring power from the transmitter to a receiver, the transmitter comprising:
an inverter electrically connected to a transmit element of the transmitter for outputting an alternating current (AC) for driving the transmit element to generate the field to wirelessly transfer power; and
circuitry for reducing a duty cycle of a switching element of an inverter of a transmitter of a wireless power transfer system to reduce electromagnetic interference (EMI) of a field generated by the transmitter, the circuitry adapted to reduce a period of time a switching element of the inverter is active during each cycle of an operating frequency of the inverter thereby reducing the duty cycle of the switching element; and
the receiver for extracting power from a field generated by the transmitter.

19. The wireless power transfer system of claim 18, wherein the receiver comprises:
a receive element for coupling to the field generated by the transmitter to extract power from the field.

20. The wireless power transfer system of claim 19, wherein the receiver comprises at least one of:
a rectifier electrically connected to the receive element for rectifying a received alternating current (AC) signal to direct current (DC); and
a load electrically connected to the receive element.
